(19) United States
(12) Patent Application Publication
(10) Pub. No.: US 2014/0372710 A1
(43) Pub. Date: Dec. 18, 2014

(54) SYSTEM AND METHOD FOR RECOVERING FROM AN UNEXPECTED SHUTDOWN IN A WRITE-BACK CACHING ENVIRONMENT

(71) Applicant: Samsung Electronics Co., Ltd., Suwon-si (KR)

(72) Inventors: Pradeep Bisht, Mountain View, CA (US); Kashif Memon, Sunnyvale, CA (US)

(21) Appl. No.: 13/920,440

(22) Filed: Jun. 18, 2013

(51) Int. Cl. G06F 12/10; G06F 12/08

(52) U.S. Cl. CPC G06F 12/1009; G06F 12/0804
USPC 711/143

(57) ABSTRACT

An invention is provided for recovering from an unexpected shutdown in a write-back caching environment. The invention includes storing a logical block address (LBA) mapping table on a caching device. The LBA mapping table maps logical block addresses of a target storage device to logical block addresses of the caching device. In addition, a LBA mapping table change log is maintained on the caching device. The LBA mapping table change log includes changes to the LBA mapping table since the LBA mapping table was last written to the caching device. During startup after an unexpected shutdown, the unexpected shutdown is detected using a header stored on a caching device. Among other data, the header includes an indicia indicating whether or not a clean shutdown occurred. When the unexpected shutdown is detected, a recovered LBA mapping table is generated based on the LBA mapping table, which is stored on the caching device, and the LBA mapping table change log.

### BACKGROUND OF THE INVENTION

1. Field of the Invention

This invention relates generally to recovering from an unexpected power loss in a caching environment, and more particularly to recovering from an unexpected power loss in a software only write back caching environment.

2. Description of the Related Art

Caching has long been used in storage environments to enhance the performance of slower storage devices, such as disk drives. In caching, a smaller and faster storage medium is utilized to temporarily store and retrieve frequently used data, while the larger and typically slower mass storage medium is used for long term storage of data. One caching methodology is write-back caching, wherein data written to a disk is first stored in a cache and later written to the mass storage device, typically when the amount of data in cache reaches some threshold value or when time permits.

FIG. 1 is a block diagram showing an exemplary prior art computer system 100 having write back caching capability. The exemplary prior art computer system 100 includes a central processing unit (CPU) 102 in communication with system memory 104, a caching device 106, and a target storage device 108. In addition, loaded into system memory 104 is caching software 110, which functions to facilitate write-back caching functionality on the computer system 100.

As mentioned previously, the caching device 106 generally comprises a smaller, faster access storage than that used for the target storage device 108. Because of the enhance speed of the caching device 106, reads and writes directed to the caching device 106 are processed much faster than is possible using the target storage device 108. Write-back caching takes advantage of these differences by sending all write requests to the caching device 106 before later transferring the data to the target storage device 108.

For example, when the CPU 102 processes a write request to write data to the target storage device 108, the caching software 110 intercepts the write request and writes the data to the caching device 106 instead. This data often is referred to as “dirty” data because it has not yet been written to the target storage device 108, and later becomes “clean” data when the data is later written to the target storage device 108. The caching software 110 provides a complete view of the target storage device 108 to the user. That is, when the CPU 102 processes a read request for the same data, the caching software 110 again intercepts the read request and determines whether the data is on the caching device 106. When the data is on the caching device 106, the CPU 102 reads the data from the caching device 106, otherwise the CPU 102 reads the data from the target storage device 108.

Traditionally, write-back caching for a boot drive is enabled by using an Option ROM of a storage controller connected to the caching device and the target storage device. For example, in FIG. 1, the CPU 102 is connected to a PCI device card 112, which stores an Option-ROM 114 in the on-board memory of the PCI device card 112. Once loaded into system memory, the Option-ROM 114 of the PCI device card 112 provides the CPU 102 access to specific hardware devices such as the caching device 106 and target storage device 108 associated with the PCI device card 112. In this case, the Option-ROM 114 includes the caching software 110 for handling the caching device 106.

At system startup, during the pre-OS environment, the system BIOS scans for the presence of hardware devices and loads the Option-ROMs, such as Option-ROM 114, from detected PCI device cards, such as PCI device card 112, into system memory 104. Each Option-ROM 114 is proprietary to the associated PCI device card 112 and is utilized to access the related PCI device and its child devices. For example, in FIG. 1 the Option-ROM 114 functions to provide access to the disk controller PCI device card 112, which provides access to the associated caching drive 106 and target storage drive 108. Once the Option-ROMs are loaded into system memory 104, the operating system files stored on target storage device 108 and/or the caching device 106 are loaded into system memory 104.

As can be appreciated, at any point in time data can be stored in the caching device 106 and not yet updated on the target storage device 108, and therefore the target storage device 108 may not have a complete and consistent copy of what then user believes is stored there. As such, problems can arise when an unexpected loss of power occurs.

As illustrated in FIG. 1, a hardware device card is required in order to allow the system BIOS to detect and load the caching software 110 stored in the Option-ROM 114 into system memory 104 in the pre-OS environment. Specifically, when a computer system boots the system BIOS detects that a card is connect then loads the associated Option-ROM code from the card into system memory and executes that code. Unfortunately, in the prior art, if there is no associated hardware, such as a PCI device card, installed in the computer system, there is no way to load an Option-ROM BIOS into system memory during the pre-OS environment.

Moreover, the amount of memory that is available during the pre-OS phase in legacy BIOSes is extremely limited, since they operate in real mode. For example, during the pre-OS phase in a legacy BIOS a single segment of 64 KB up to 1 MB is available. As such, performing recovery in such a low memory environment with larger cache sizes is extremely difficult and can require long periods of time to perform properly.

In view of the foregoing, there is a need for systems and methods for enabling recovery from an unexpected loss of power for a software only write-back caching environment. This recovery should allow for recovery of a boot drive in a software only environment write-back caching environment, and be able to perform recovery in a legacy BIOS system architecture. Moreover, the methods should be capable of processing the recovery operations without requiring long periods of time for proper processing.

### SUMMARY OF THE INVENTION

Broadly speaking, embodiments of the present invention address these needs by maintaining a change log for logical address mapping on the caching device and utilizing the change log to reconstruct a current logical mapping table for the caching device and target storage device in the event of an unexpected shutdown. For example, in one embodiment, a method is disclosed for recovering from an unexpected shutdown in a write-back caching environment. The method includes storing a logical block address (LBA) mapping table on a caching device. The LBA mapping table maps logical block addresses of a target storage device to logical block addresses of the caching device. In addition, a LBA mapping table change log is maintained on the caching device. The LBA mapping table change log includes changes to the LBA mapping table since the LBA mapping table was last written to the caching device. During startup after an unexpected shutdown, the unexpected shutdown is detected using a header stored on a caching device. Among other data, the header includes an indicia indicating whether or not a clean shutdown occurred. When the unexpected shutdown is detected, a recovered LBA mapping table is generated based on the LBA mapping table, which is stored on the caching device, and the LBA mapping table change log. Once generated, the recovered LBA mapping table can be written to the caching device and normal caching operations can commence.

In an additional embodiment, a system is disclosed for recovering from an unexpected shutdown in a write-back caching environment. The system includes a target storage device and a caching device utilized to cache data for the target storage device. Further included is a LBA mapping table stored on the caching device. As above, the LBA mapping table maps logical block addresses of a target storage device to logical block addresses of the caching device. In addition, a LBA mapping table change log is stored the caching device that includes changes to the LBA mapping table stored on the caching device since the LBA mapping table was last written to the caching device. Also stored on the caching device is a header that includes an indicia indicating whether a clean shutdown occurred. In the event of an unexpected shutdown, a recovered LBA mapping table is generated based on the LBA mapping table stored on the caching device and the LBA mapping table change log in response to detecting an unexpected shutdown. Thereafter, normal caching operations can occur in which a current LBA mapping table is maintained is system memory.

A further method for recovering from an unexpected shutdown in a write-back caching environment is disclosed in an additional embodiment of the present invention. The method includes storing a LBA mapping table on a caching device and maintaining a LBA mapping table change log on the caching device that includes changes to the LBA mapping table on the caching device since the LBA mapping table was last written to the caching device. During startup after an unexpected shutdown, the unexpected shutdown is detected using a header stored on a caching device. Among other data, the header includes an indicia indicating whether or not a clean shutdown occurred. During startup, code is loaded from a boot sector of a designated boot device into system memory and the code loads an Option-ROM BIOS having caching software into system memory. When the unexpected shutdown is detected, the caching software generates a recovered LBA mapping table based on the LBA mapping table, which is stored on the caching device, and the LBA mapping table change log. Once generated, the recovered LBA mapping table can be written to the caching device and normal caching operations can commence. During recovery, data is loaded from the LBA mapping table from the caching device into system memory below 1 MB. Then, entries of the LBA mapping table are inserted into nodes of a tree data structure in system memory above 1 MB. To help facilitate recovery, one embodiment places the central processing unit (CPU) in protected mode. Other aspects and advantages of the invention will become apparent from the following detailed description, taken in conjunction with the accompanying drawings, illustrating by way of example the principles of the invention.

### BRIEF DESCRIPTION OF THE DRAWINGS

The invention, together with further advantages thereof, may best be understood by reference to the following description taken in conjunction with the accompanying drawings in which:

FIG. 1 is a block diagram showing an exemplary prior art computer system having write back caching capability;

FIG. 2 is a block diagram showing an exemplary computer system having device-less caching and power loss recovery ability, in accordance with an embodiment of the present invention;

FIG. 3 is a diagram showing the exemplary designated boot device, having a device-less ROM boot record (DRBR) for facilitating device-less less caching and power loss recovery ability, in accordance with an embodiment of the present invention;

FIG. 4 is a block diagram showing the exemplary computer system after loading the device-less Option-ROM BIOS into system memory, in accordance with an embodiment of the present invention;

FIG. 5 is a diagram illustrating the recovery data structures maintained by the caching software in the exemplary computer system, in accordance with an embodiment of the present invention;

FIG. 6 is a flowchart showing a method for updating the recovery data structures during a normal clean shutdown, in accordance with an embodiment of the present invention;

FIG. 7 is a flowchart showing a method for recovering from an unexpected power loss, in accordance with an embodiment of the present invention; and

FIG. 8 is a diagram illustrating memory usage during LBA mapping table recovery, in accordance with an embodiment of the present invention.

### DETAILED DESCRIPTION OF THE PREFERRED EMBODIMENTS

An invention is disclosed for recovering after an unexpected shutdown in a write back caching environment using device-less caching software. In general, embodiments of the present invention maintain a current copy of the logical block address mapping table in system memory and log all changes to the table since the table was last committed (i.e., stored) to the caching device. During recovery, the prior stored mapping table and the change log are utilized to recover the current mapping table. In so doing, embodiments of the present invention place the CPU in protected mode in order to store and process table entries in an AVL tree in extended memory (i.e., above 1 MB).

In the following description, numerous specific details are set forth in order to provide a thorough understanding of the present invention. It will be apparent, however, to one skilled in the art that the present invention may be practiced without some or all of these specific details. In other instances, well known process steps have not been described in detail in order not to unnecessarily obscure the present invention.

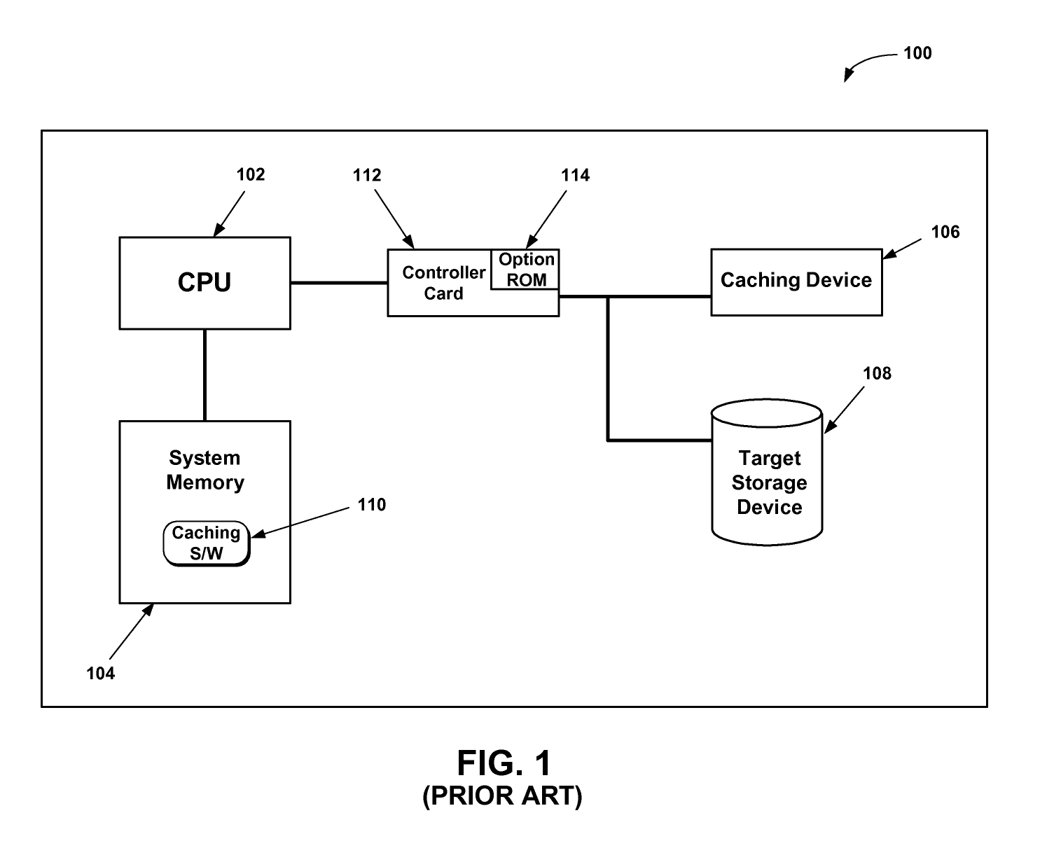

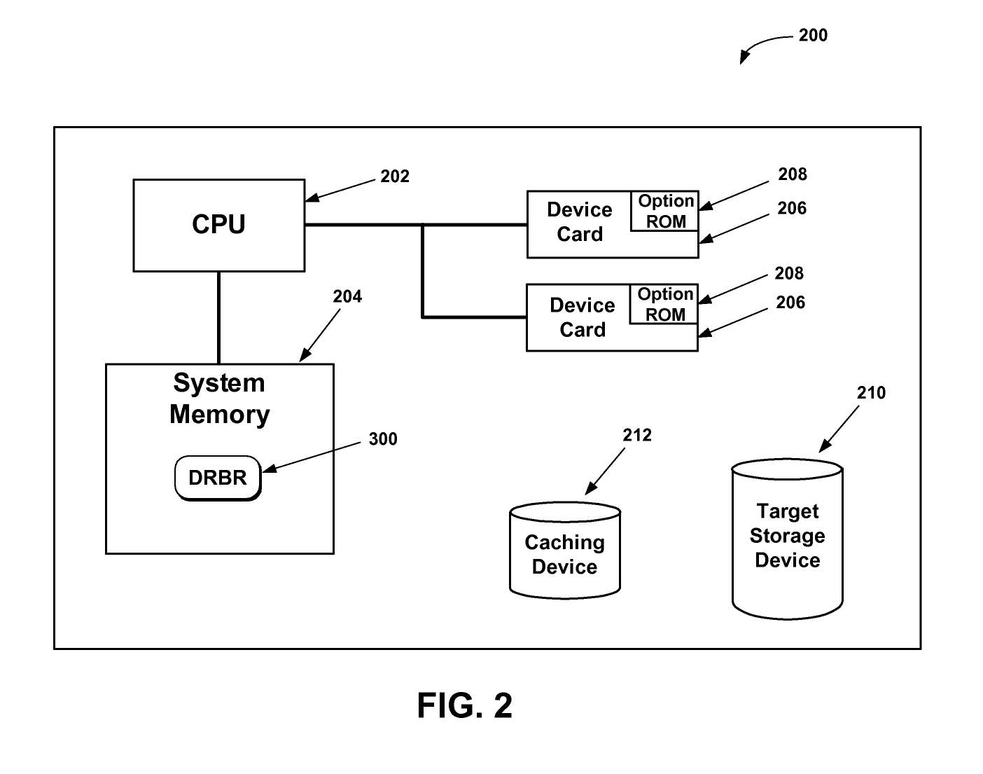

FIG. 1 was described in terms of the prior art. FIG. 2 is a block diagram showing an exemplary computer system 200 having device-less caching and power loss recovery ability, in accordance with an embodiment of the present invention. The computer system 200 includes a central processing unit (CPU) 202 connected to system memory 204 and a plurality of device cards 206. Each device card 206 can include an Option-ROM BIOS 208 stored in the ROM/flash memory present on each device card 206. Further included in the computer system 200 is a target storage device 210 and a caching device 212.

The target storage device 210 can be any storage device wherein the CPU 202 can write data to and read from during normal operation of the computer system 200. The caching device 212 generally is a smaller and faster access disk than that used for the target storage device 210. For example, the caching device 212 can be a solid state drive (SSD) such as NAND flash based SSD or phase change memory (PCM). Because of the enhance speed of the caching device 212, reads and writes directed to the caching device 212 are processed much faster than is possible using the target storage device 210. Write-back caching takes advantage of these differences by sending all write requests to the caching device 212 before later transferring the data to the target storage device 210. Caching software provides a complete view of the target storage device 210, so the user always sees a complete view of the target storage device 210, regardless of whether or not some data is actually stored on the caching device 212.

In general, the first code executed by the CPU 202 during system startup is the system BIOS, which sets up the hardware for the computer system 200 and loads the operating system. To do this, the system BIOS scans the computer system 200 for hardware, such as the device cards 206, and loads the Option-ROM BIOS 208 for each device card 206. In this manner, each loaded and executed Option-ROM BIOS 208 provides access to the related device card 206 and its child devices during the pre-OS environment.

The system BIOS then identifies a designated boot device, such as the target storage device 210 and attempts to load the operating system (OS) software that further controls the computer system 200. In prior art computer systems, the system BIOS loaded the master boot record (MBR) from the boot sector of the designated boot device to facilitate loading the operating system. The MBR generally was stored in sector 0 of the designated boot device, and consisted of machine code that once executed facilitated loading and execution of the OS files, before transferring control to the OS. However, embodiments of the present invention replace the MBR with a device-less ROM boot record (DRBR) to facilitate loading of a device-less Option-ROM.

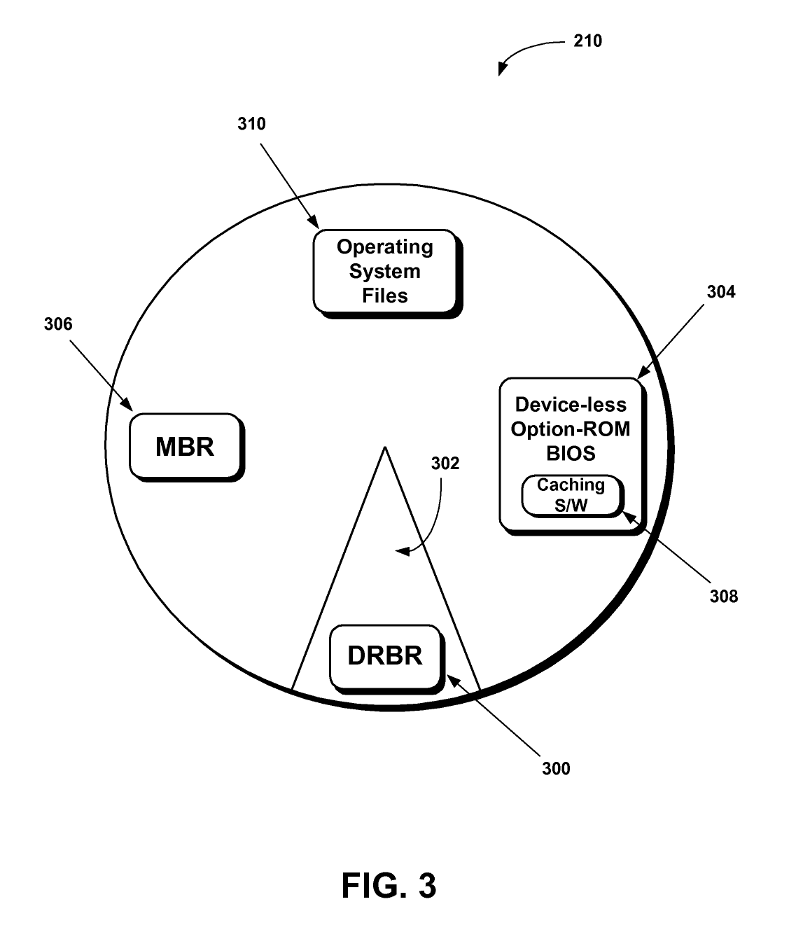

FIG. 3 is a diagram showing the exemplary designated boot device 210, having a device-less ROM boot record (DRBR) 300 for facilitating device-less less caching and power loss recovery ability, in accordance with an embodiment of the present invention. The designated boot device 210 includes a DRBR 300 located in the boot sector 302 of the designated boot device 210. In addition, a device-less Option-ROM BIOS 304 that includes caching software 308, is stored on the designated boot device 210, as well as a master boot record (MBR) 306, and the operating system files 310. Although FIG. 3 shows both the device-less Option-ROM BIOS 304 and MBR 306 stored on the designated boot device 210, it should be noted that either the device-less Option-ROM BIOS 304, the MBR 306 or both can be stored on an alternate storage device, such as a caching device.

As mentioned above, after loading the Option-ROM BIOS code from hardware installed on the computer system during startup, the system BIOS loads code from the boot sector 302 (e.g., sector 0). However, embodiments of the present invention replace the MBR 306 normally stored at the boot sector 302 with the DRBR 300 to facilitate loading of a device-less Option-ROM 304. Thus, during startup in the embodiment of FIG. 3, the system BIOS loads the DRBR 300 from the boot sector 302 (e.g., sector 0) into system memory.

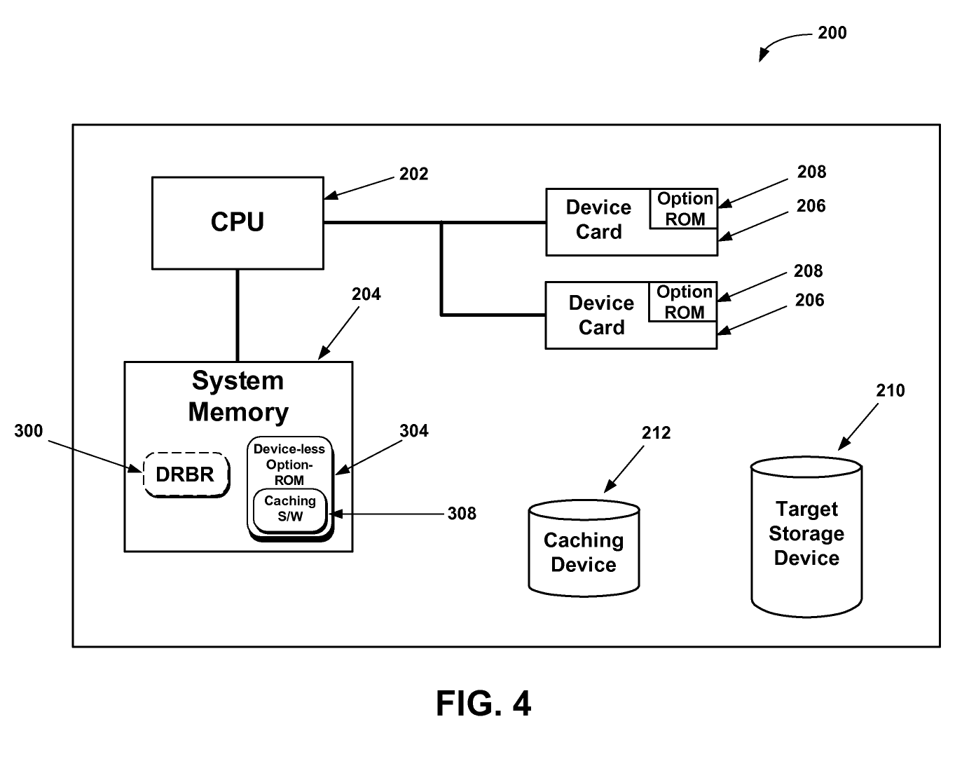

Referring to FIGS. 2 and 3, after loading the Option-ROM BIOS code 208 from hardware 206 installed on the computer system 200, the system BIOS loads the DRBR 300 from the boot sector of the designated boot device 210 into system memory 204. The DRBR 300 includes data, such as a pointer, identifying the location of the device-less Option-ROM BIOS 304 stored on the designated boot device 210 or other storage device. Once the DRBR 300 code is loaded from the boot sector 302 into system memory 204, the DRBR 300 functions to load the device-less Option-ROM BIOS 304 into system memory 204 as illustrated in FIG. 4.

FIG. 4 is a block diagram showing the exemplary computer system 200 after loading the device-less Option-ROM BIOS 304 into system memory 204, in accordance with an embodiment of the present invention. In FIG. 4, the computer system 200 includes the CPU 202 connected to a plurality of device cards 206, each including an Option-ROM BIOS 208. In addition, both the DRBR 300 and the device-less Option-ROM BIOS 304 with caching software 308 have been loaded into system memory 204.

Once the device-less Option-ROM BIOS 304 is loaded into system memory 204, the DRBR 300 transfers control to it. In this manner, the device-less Option-ROM BIOS 304 is now free to operate as if it was loaded into memory from a PCI device. The device-less Option-ROM BIOS 304 includes caching software 308 that filters pre-OS input/output (IO). Along these lines, when the OS is being loaded, the caching software 308 of the device-less Option-ROM BIOS 304 can intercept selected portions of the IO and serve the data from another device.

The device-less Option-ROM BIOS 304 further includes data, such as a pointer, identifying the location of the MBR 306 stored on the designated boot device 210 or on an alternate storage device (e.g., cache disk device). Once the device-less Option-ROM BIOS 304 code has completed setting itself up and initializing, the device-less Option-ROM BIOS 304 loads the MBR 306 into system memory 204.

In this manner, the caching software 308 of the device-less Option-ROM BIOS 304 can facilitate disk caching in the pre-OS environment, before the operating system is loaded into system memory. Because the caching software 308 is loaded and executed prior to loading the OS, the caching software 308 can filter the IO associated with loading the OS into system memory 204. Thus, the caching software 308 can intercept various IO requests and redirect specific request to a caching device other than the designated boot device, allowing operating system files to be loaded from different disks. In addition, the device-less, pre-OS caching software 308 allows recovery of the target storage device and the caching device to a consistent state after an unexpected shutdown.

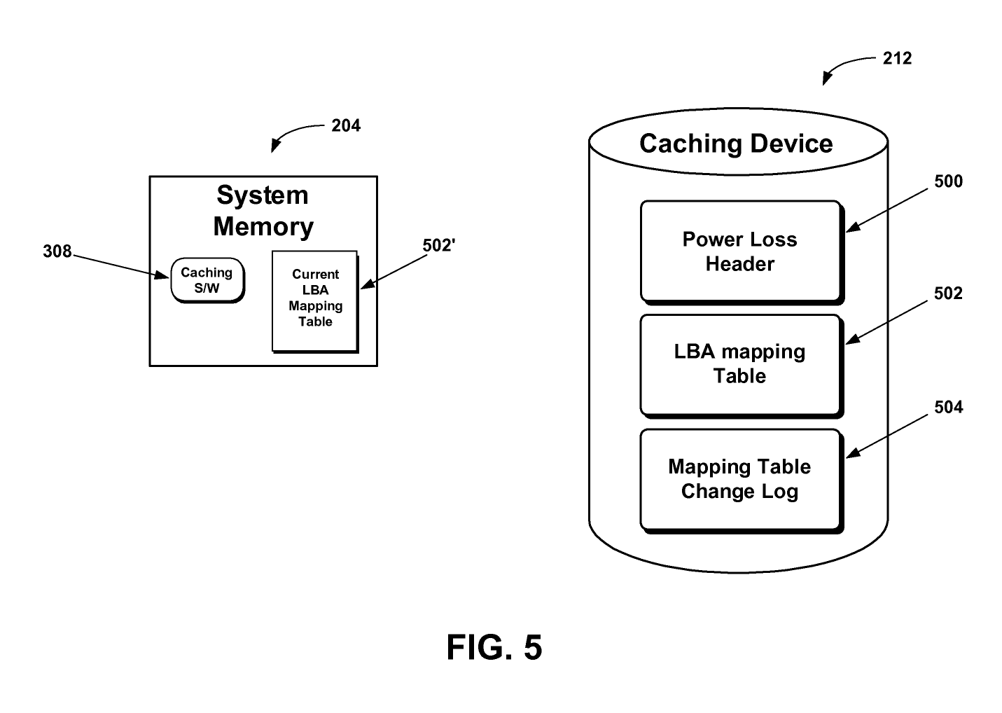

FIG. 5 is a diagram illustrating the recovery data structures maintained by the caching software 308 in the exemplary computer system 200, in accordance with an embodiment of the present invention. In particular FIG. 5 shows the caching software 308 loaded into system memory 204. To facilitate power loss recovery, the caching software 308 maintains power loss header 500, a logical block address (LBA) mapping table 502, and a mapping table change log 504 on the caching device 212. In addition, the caching software 308 maintains a current LBA mapping table 502′ in the system memory 204.

The power loss header 500 is maintained at a predefined address and includes an indicator that indicates when an unexpected shutdown has occurred. As will be described in greater detail subsequently, the caching software 308 uses the power loss header 500 to determine when an unexpected shutdown has occurred. In addition, the power loss header 500 includes the address of the LBA mapping table 502 and the mapping table change log 504 in cache memory. The caching software 308 uses these address locations during recovery.

The LBA mapping table 502 maps the target storage device 210 logical block addresses to the caching device 212 logical block addresses. However, as will be discussed in greater detail below, the LBA mapping table 502 generally is updated upon system shutdown and upon recovery from a loss of power. As such, the LBA mapping table 502 stored on the caching device 212 often does not store current mapping data during normal caching operation. The current LBA mapping table 502′ is maintained in system memory 204.

The mapping table change log 504 includes the changes to the LBA mapping table 502 since the last point at which the LBA mapping table 502 was successfully written to the caching device 212. As such, the mapping table change log 504 is continuously updated by the caching software 308 as changes are made to the current LBA mapping table 502′. During recovery, the mapping table change log 504 facilitates reconstruction of an up to date LBA mapping table.

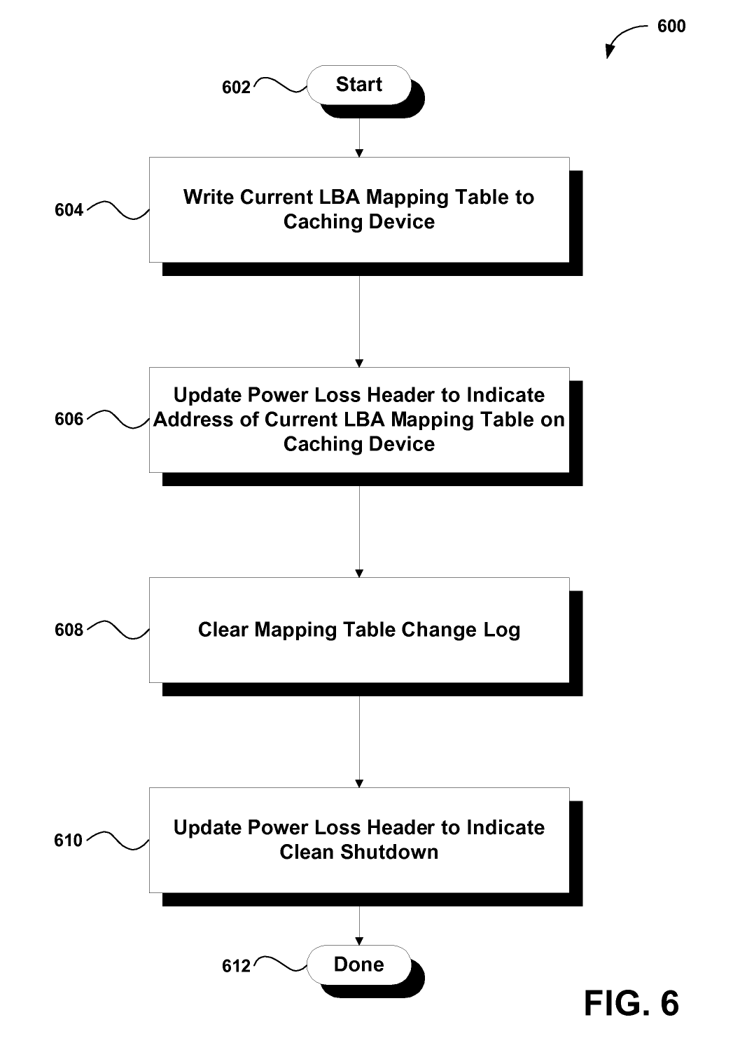

FIG. 6 is a flowchart showing a method 600 for updating the recovery data structures during a normal clean shutdown, in accordance with an embodiment of the present invention. During a normal clean shutdown, for example when responding to a user request to shut the system down, embodiments of the present invention update the recovery structures stored on the caching device. In operation 602, preprocess operations are performed. Preprocess operations can include, for example, receiving a shutdown command, performing preliminary shutdown procedures, and other preprocess operations that will be apparent to those skilled in the art after a careful reading of the present disclosure.

In operation 604, the current LBA mapping table is written to the caching device. Referring to FIG. 5, during normal operation the caching software 308 maintains the current LBA mapping table 502′ in system memory 204. The current LBA mapping table 502′ is updated each time data is cached or removed from the cache memory in the caching device 212. In response to a normal clean shutdown the caching software 308 writes the current LBA mapping table 502′ to the caching device 212, in effect replacing the prior LBA mapping table 502.

Turning back to FIG. 6, the power loss header then is updated to indicate the address of the current LBA mapping table, in operation 606. Often, when data is updated on the caching device, the new data is written to a new address. This is particularly true when using a solid state drive (SSD) such as a flash memory device as the caching device. As such, when the current LBA mapping table is written to the caching device in operation 604, the LBA mapping table is stored in a different address than the prior LBA mapping table. Thus, in operation 606, the power loss header is updated to indicate the new address of the LBA mapping table.

In operation 608, the mapping table change log is cleared. Referring to FIG. 5, during normal caching operations the caching software 308 logs all changes to the LBA mapping table 502 since the LBA mapping table 502 was last committed to the caching device 212. These changes are stored in the mapping table change log 504, which is continuously updated as changes are made to the LBA mapping table in response to data caching. In response to a normal clean shutdown, the current LBA mapping table 502′ is written to the caching device 212, and thus all the changes to the prior LBA mapping table 502 are effectively saved. Hence, in operation 608, the mapping table change log 504 is cleared.

In operation 610, the power loss header is updated to indicate that a clean shutdown occurred. Referring to FIG. 5, during startup the caching software 308 examines the power loss header 500 to determine whether or not the last shutdown occurred as a result of a normal clean shutdown. If the power loss header 500 indicates the last shutdown occurred as a result of a normal clean shutdown, normal caching operations can commence. Otherwise, the caching software begins recovery operations. Hence, in operation 610, the caching software updates the power loss header to indicate that a clean shutdown occurred.

The method 600 ends in operation 612. After updating the recovery data structures during a normal clean shutdown, the caching device 212 stores the current LBA mapping table and the power loss header indicates that the last shutdown was a normal clean shutdown. As a result, during the next startup the caching software will examine the power loss header and detect that a normal clean shutdown occurred. As a result, the caching software 308 loads the LBA mapping table 502, which is now current, into system memory 204 and normal caching operations can begin.

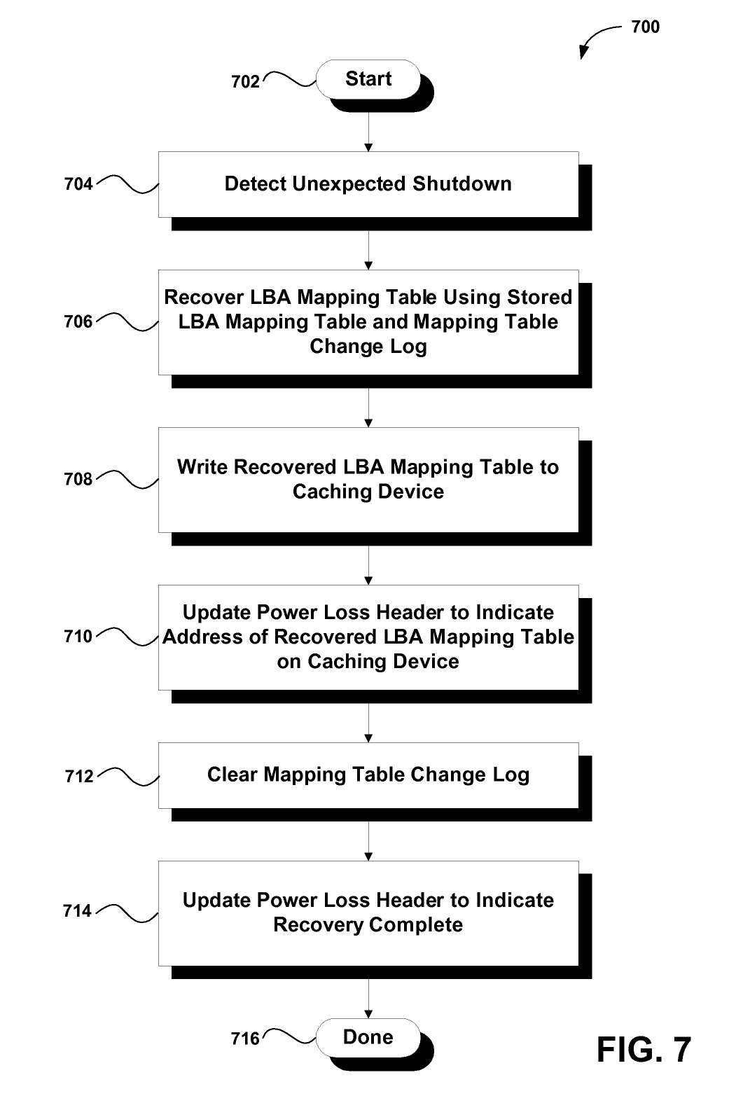

FIG. 7 is a flowchart showing a method 700 for recovering from an unexpected shutdown, in accordance with an embodiment of the present invention. In operation 702, preprocess operations are performed. Preprocess operations can include, for example, loading a device-less Option ROM BIOS into system memory, starting caching software included in the device-less Option ROM BIOS, and other preprocess operations that will be apparent to those skilled in the art with the hindsight provided by a careful reading of the present disclosure.

In operation 704, the caching software detects that an unexpected shutdown occurred. Referring to FIG. 5, during a normal clean shutdown the caching software 308 updates the power loss header 500 to indicate that that the last shutdown occurred as a result of a normal clean shutdown. Unless the power loss header 500 indicates that the last shutdown occurred as a result of a normal clean shutdown, an unexpected shutdown has occurred. During the next startup the caching software 308 examines the power loss header 500 to determine whether or not the last shutdown occurred as a result of a normal clean shutdown. If power loss header 500 does not indicate that the last shutdown occurred as a result of a normal clean shutdown, the caching software 308 detects that an unexpected shutdown occurred.

Turing back to FIG. 7, the LBA mapping table then is recovered using the LBA mapping table stored on the caching device and the mapping table change log, in operation 706. Referring to FIG. 5, when the caching software 308 detects during startup that an unexpected shutdown occurred, it needs to recover the current LBA mapping table. This is accomplished by updating the LBA mapping table 502 stored on the caching device 212 using the mapping table change log 504. Since all changes to the LBA mapping table 502 since the last time it was committed to the caching device were logged in the mapping table change log 504, the mapping table change log 504 can be utilized to update the LBA mapping table 502 and create a recovered current LBA mapping table.

Turning back to FIG. 7, once the LBA mapping table is recovered, the recovered LBA mapping table is written to the caching device, in operation 708. Then, in operation 710, the power loss header is updated to indicate the address of the recovered LBA mapping table. Often, when data is updated on an SSD caching device, the new data is written to a new address. As such, when the recovered LBA mapping table is written to the caching device, the recovered LBA mapping table is stored in a different address than the prior LBA mapping table. Thus, in operation 710, the power loss header is updated to indicate the new address of the recovered LBA mapping table.

In operation 712, the mapping table change log is cleared. Referring to FIG. 5, during normal caching operations the caching software 308 logs all changes to the LBA mapping table 502 since the LBA mapping table 502 was last committed to the caching device 212. These changes are stored in the mapping table change log 504, which is continuously updated as changes are made to the LBA mapping table in response to data caching. In response to an unexpected shutdown, the LBA mapping table is recovered and the recovered LBA mapping table is written to the caching device 212, and thus all the changes to the prior LBA mapping table 502 are effectively saved. Hence, in operation 712, the mapping table change log 504 is cleared.

In operation 714, the power loss header is updated to indicate that recovery is complete. Referring to FIG. 5, during startup the caching software 308 examines the power loss header 500 to determine whether or not the last shutdown occurred as a result of a normal clean shutdown. If power loss header 500 does not indicate that the last shutdown occurred as a result of a normal clean shutdown, the caching software 308 detects that an unexpected shutdown occurred. Once the LBA mapping table is recovered and committed to the caching device 212, caching software 308 updates the power loss header 500 to indicate that recovery is complete.

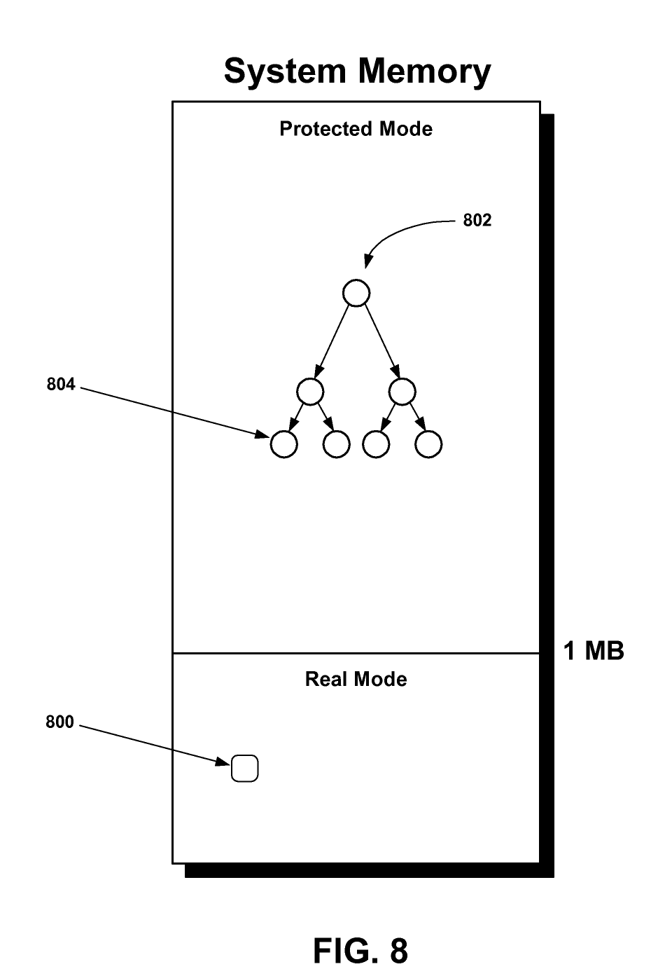

The method 700 completes in operation 716. One challenge that occurs in legacy BIOSes is the limited amount of memory available in the pre-OS environment in which recovery operations are performed. Generally, these legacy environments operate in real mode during the pre-OS environment. Real mode restricts the available memory to 1mega byte (MB) and below. Large amounts of dirty data on the caching disk increases the amount of log entries that need to be processed. The number of log entries also increases significantly with the changing data which triggers evictions from the cache leading to changes in the LBA mapping table. This further increases the time required to process the log entries, and hence, the time to perform recovery. To address theses challenges, embodiments of the present invention use AVL trees to represent the LBA mapping table during the recovery process, as described next with reference to FIG. 8.

FIG. 8 is a diagram illustrating memory usage during LBA mapping table recovery, in accordance with an embodiment of the present invention. As mentioned previously, legacy environments generally operate in real mode during the pre-OS, which restricts the available memory to 1 MB and below, as illustrated in FIG. 8. As such, when performing recovery, embodiments of the present invention read small units 800 of data from the LBA mapping table stored on the caching device into a small buffer in the real mode addressable memory space, which is below 1 MB. For example, the units 800 of data can be four kilobytes (4 KB) in size.

Once enough units 800 of data are gathered together to form an LBA mapping table entry, the LBA mapping table entry is inserted into an AVL tree 802 as a mapping entry node 804. The AVL tree 802 is a self balancing binary search tree, and is located in the protected mode addressable memory space, which is above 1 MB. However, as mentioned above, legacy environments generally operate in real mode during the pre-OS, which restricts the available memory to 1 MB and below.

Hence, embodiments of the present invention place the CPU in protected mode. Real mode is a legacy mode of operation based on old 8086 Intel architecture where the only addressable memory space was up to 1 MB. To maintain backwards compatibility, real mode was maintained in many later legacy CPUs. Protected mode allows applications to address memory above the 1 MB limited on real mode. Hence, the CPU is placed in protected mode to provide access to memory above the 1 MB limit set in real mode. In this manner, whenever the caching software needs to process a mapping node 804 in the AVL tree, the caching software can process the node in the memory above 1 MB. This avoids any requirements to copy data back and forth between the memory above 1 MB and memory below 1 MB.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A method for recovering from an unexpected shutdown in a write-back caching environment, comprising:
storing a logical block address (LBA) mapping table on a caching device, wherein the LBA mapping table maps logical block addresses of a target storage device to logical block addresses of the caching device;
maintaining a LBA mapping table change log on the caching device, wherein the LBA mapping table change log includes changes to the LBA mapping table on the caching device since the LBA mapping table was last written to the caching device;
detecting an unexpected shutdown using a header stored on a caching device, wherein the header includes an indicia indicating whether a clean shutdown occurred; and
generating a recovered LBA mapping table based on the LBA mapping table stored on the caching device and the LBA mapping table change log.

2. A method as recited in claim 1, further comprising writing the recovered LBA mapping table to the caching device.

3. A method as recited in claim 1, further comprising maintaining a current LBA mapping table in system memory during normal caching operations.

4. A method as recited in claim 1, further comprising placing a central processing unit (CPU) in protected mode.

5. A method as recited in claim 1, further comprising loading data from the LBA mapping table from the caching device into system memory below 1 MB.

6. A method as recited in claim 5, further comprising inserting entries of the LBA mapping table into nodes of a tree data structure in system memory above 1 MB.

7. A method as recited in claim 1, further comprising loading code from a boot sector of a designated boot device into system memory, wherein the code loads an Option-ROM BIOS into system memory, and wherein the Option-ROM BIOS includes caching software.

8. A system for recovering from an unexpected shutdown in a write-back caching environment, comprising:
a target storage device;
a caching device utilized to cache data for the target storage device;
a logical block address (LBA) mapping table on the caching device, wherein the LBA mapping table maps logical block addresses of a target storage device to logical block addresses of the caching device;
a LBA mapping table change log stored the caching device, wherein the LBA mapping table change log includes changes to the LBA mapping table on the caching device since the LBA mapping table was last written to the caching device; and
a header stored on the caching device, wherein the header includes an indicia indicating whether a clean shutdown occurred,
wherein a recovered LBA mapping table is generated based on the LBA mapping table stored on the caching device and the LBA mapping table change log in response to detecting an unexpected shutdown.

9. A system as recited in claim 8, wherein the recovered LBA mapping table is written to the caching device after being generated.

10. A system as recited in claim 8, further comprising a current LBA mapping table stored system memory during normal caching operations.

11. A system as recited in claim 8, further comprising a central processing unit (CPU) operating in protected mode.

12. A system as recited in claim 8, wherein data from the LBA mapping table is loaded from the caching device into system memory below 1 MB.

13. A system as recited in claim 12, wherein entries of the LBA mapping table are inserted into nodes of a tree data structure in system memory above 1 MB.

14. A system as recited in claim 8, further comprising code stored on a boot sector of a designated boot device, wherein the code is loaded from the boot sector into system memory, and wherein the code loads an Option-ROM BIOS into system memory, the Option-ROM BIOS including caching software.

15. A method for recovering from an unexpected shutdown in a write-back caching environment, comprising:
storing a logical block address (LBA) mapping table on a caching device, wherein the LBA mapping table maps logical block addresses of a target storage device to logical block addresses of the caching device;
maintaining a LBA mapping table change log on the caching device, wherein the LBA mapping table change log includes changes to the LBA mapping table on the caching device since the LBA mapping table was last written to the caching device;
detecting an unexpected shutdown using a header stored on a caching device, wherein the header includes an indicia indicating whether a clean shutdown occurred;
loading code from a boot sector of a designated boot device into system memory, wherein the code loads an Option-ROM BIOS having caching software into system memory; and
generating a recovered LBA mapping table based on the LBA mapping table stored on the caching device and the LBA mapping table change log.

16. A method as recited in claim 15, further comprising writing the recovered LBA mapping table to the caching device.

17. A method as recited in claim 15, further comprising maintaining a current LBA mapping table in system memory during normal caching operations.

18. A method as recited in claim 15, further comprising placing a central processing unit (CPU) in protected mode.

19. A method as recited in claim 15, further comprising loading data from the LBA mapping table from the caching device into system memory below 1 MB.

20. A method as recited in claim 15, further comprising inserting entries of the LBA mapping table into nodes of a tree data structure in system memory above 1 MB.
